(19) United States
(12) Patent Application Publication
(10) Pub. No.: US 2023/0258139 A1
(43) Pub. Date: Aug. 17, 2023

(54) VEHICLE CONTROL SYSTEM

(71) Applicant: TOYOTA JIDOSHA KABUSHIKI KAISHA, Aichi-ken (JP)

(72) Inventors: Hirotaka SASAKI, Nagoya-shi (JP); Takahisa KANEKO, Toyota-shi (JP); Masahiro NISHIYAMA, Toyota-shi (JP); Kenji TSUKAGISHI, Toyota-shi (JP)

(21) Appl. No.: 18/155,065

(22) Filed: Jan. 17, 2023

(30) Foreign Application Priority Data
Jan. 21, 2022 (JP) 2022-007550

(51) Int. Cl. F02D 41/02; F02D 41/12; B60H 1/32

(52) U.S. Cl. CPC F02D 41/021; B60H 1/3208; F02D 41/123; B60H 2001/3272; B60H 2001/3282

(57) ABSTRACT

A vehicle control system is provided, in which an engine ECU starts fuel cut control when deceleration is requested, and an air conditioner ECU operates a compressor to accumulate the cold while the fuel cut control operation is performed by an engine controller, and deactivates the compressor in a case where an evaporator temperature matches or falls below a compressor deactivatable temperature when a condition for terminating the fuel cut control is satisfied. The engine ECU extends the fuel cut control in a case where the compressor is deactivated when the condition for terminating the fuel cut control is satisfied. The air conditioner ECU includes an airflow volume decreasing unit configured to decrease an airflow volume from a blower, which blows air into a vehicle interior, when an estimated air conditioning load is low during the operation to accumulate the cold, for rapidly decreasing the evaporator temperature.

### CROSS REFERENCE TO RELATED APPLICATION

This application claims priority to Japanese Patent Application No. 2022-007550 filed on Jan. 21, 2022, which is incorporated herein by reference in its entirety including the specification, claims, drawings, and abstract.

### TECHNICAL FIELD

The present disclosure relates to a vehicle control system in which a compressor is operated to cool an evaporator for accumulating the cold therein while fuel cut control is performed, and the compressor is deactivated in a case where a temperature of the evaporator matches or falls below a predetermined temperature when a condition of terminating the fuel cut control is satisfied.

### BACKGROUND

There are vehicle air conditioners equipped with a compressor which is driven by an engine for travelling. In some cases, the engine may be operated with fuel cut control to stop fuel supply to the engine during deceleration of the vehicle.

In the vehicle air conditioners as described above, the compressor is operated to cool an evaporator for accumulating the cold therein (hereinafter, referred to as cold accumulation control) while the fuel cut control is engaged, and the compressor is deactivated when the temperature of an evaporator matches or falls below a predetermined temperature at the time of terminating the fuel cut control.

During cooling operation of the vehicle air conditioners, a cooling capacity is determined based on an evaporator temperature (evaporation temperature) and a volume of air supplied into a vehicle interior. For example, JP H10-035245 A1 discloses a vehicle air conditioner in which a target evaporator temperature is changed based on the volume of air.

In the vehicle air conditioners as described above, when an air conditioning load is low, it is desired that fuel cut control be extended in order to improve fuel efficiency, by rapidly decreasing the evaporator temperature to a predetermined temperature during operation under the cold accumulation control, to deactivate the compressor when a condition of terminating the fuel cut control is satisfied.

Given these circumstances, it is an object of the present disclosure to provide a vehicle control system in which fuel efficiency of a vehicle can be improved by increasing the occurrence of situations where fuel cut control is extended.

### SUMMARY

A vehicle control system according to the present disclosure includes an engine controller which performs fuel cut control for stopping fuel supply to an engine, and an air conditioner controller which controls an air conditioner equipped with a compressor which is driven by a rotational driving force of the engine, in which the engine controller is configured to engage the fuel cut control in response to a request for deceleration, the air conditioner controller is configured to operate the compressor for accumulating the cold when the fuel cut control is being performed by the engine controller and deactivate the compressor in a case where a temperature of an evaporator matches or falls below a predetermined value of a compressor deactivatable temperature when a condition of terminating the fuel cut control is satisfied, and the engine controller is further configured to extend the fuel cut control in a case where the compressor is deactivated when the condition of terminating the fuel cut control is satisfied. In the vehicle control system, the air conditioner controller includes an airflow volume decreasing unit configured to decrease an airflow volume supplied by a blower into a vehicle interior for rapidly lowering a temperature of an evaporator when an estimated air conditioner load is low during operation to accumulate the cold.

In this way, the temperature of the evaporator is rapidly decreased during operation of cold accumulation control so as to match or fall below the compressor deactivatable temperature when the condition of terminating the fuel cut control is satisfied, which can increase the occurrence of a situation in which the compressor is deactivated, and thus increase the occurrence of situations where the fuel cut control is extended.

In the vehicle control system according to an aspect of the present disclosure, the air conditioner controller may include an air conditioning load estimator which is configured to estimate an air conditioning load based on at least one of an outside air temperature, a target blowoff temperature, and a vehicle interior temperature.

In the vehicle control system according to another aspect of the present disclosure, the air conditioner controller may include an airflow volume increasing unit which is configured to increase the airflow volume supplied by the blower, in order to gradually decrease the temperature of the evaporator when an amount of deceleration requesting time is expected to be great during operation to accumulate the cold.

In this way, the occurrence of situations where the compressor is deactivated due to freeze prevention control can be decreased by gradually lowering the temperature of the evaporator during operation under the cold accumulation control, which can, in turn, allow the air conditioner to use the rotational driving energy during operation at the time of fuel cut control without wasting the energy, in order to accumulate the cold.

In the vehicle control system according to this disclosure, the occurrence of situations where the fuel cut control is extended can be increased, which can, in turn, improve the fuel efficiency of the vehicle.

### BRIEF DESCRIPTION OF DRAWINGS

Embodiments of the present disclosure will be described based on the following figures, wherein:

FIG. 1 is a schematic diagram showing a vehicle incorporating a vehicle control system in an example according to an embodiment;

FIG. 2 is a schematic diagram showing the vehicle control system in the example according the embodiment;

FIG. 3 is a block diagram showing a configuration of the vehicle control system in the example according to the embodiment;

FIG. 4 is a graph representing a relationship between an airflow volume supplied by a blower and an outside air temperature;

FIG. 5 is a graph representing a relationship between the airflow volume supplied by the blower and a target blowoff temperature;

FIG. 6 is a flowchart showing a flow of actions of the vehicle control system; and

FIG. 7 is a timing chart showing changes in a vehicle speed, a status of fuel cut control flag, changes in the airflow volume supplied by the blower, changes in a compressor output, and changes in an evaporator temperature.

### DESCRIPTION OF EMBODIMENTS

Hereinafter, an example according to an embodiment of the present disclosure will be explained. In the following description, specific shapes, materials, directions, numerical values, and other elements will be presented by way of illustration to facilitate understanding of this disclosure, and may be changed as appropriate depending on applications, purposes, and specifications, for example.

### Vehicle

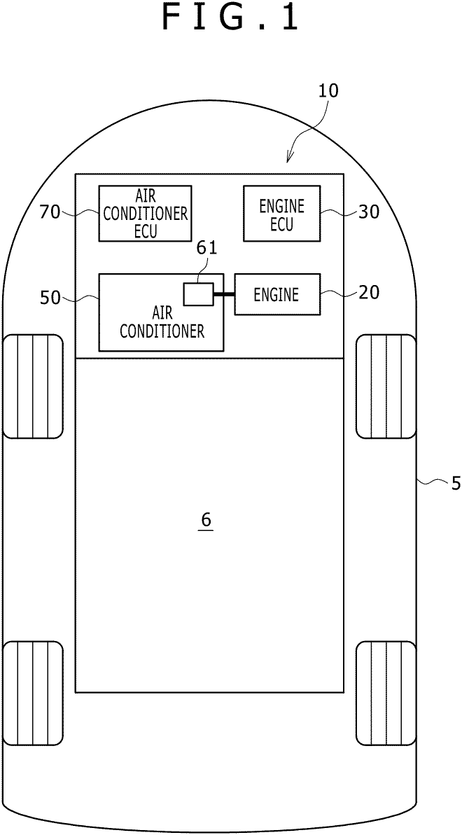

A vehicle 5 equipped with a vehicle control system 10 which is an example according to an embodiment is explained with reference to FIG. 1.

The vehicle 5 includes the vehicle control system 10. The vehicle 5 is an engine vehicle having an engine 20 for travelling.

### Vehicle Control System

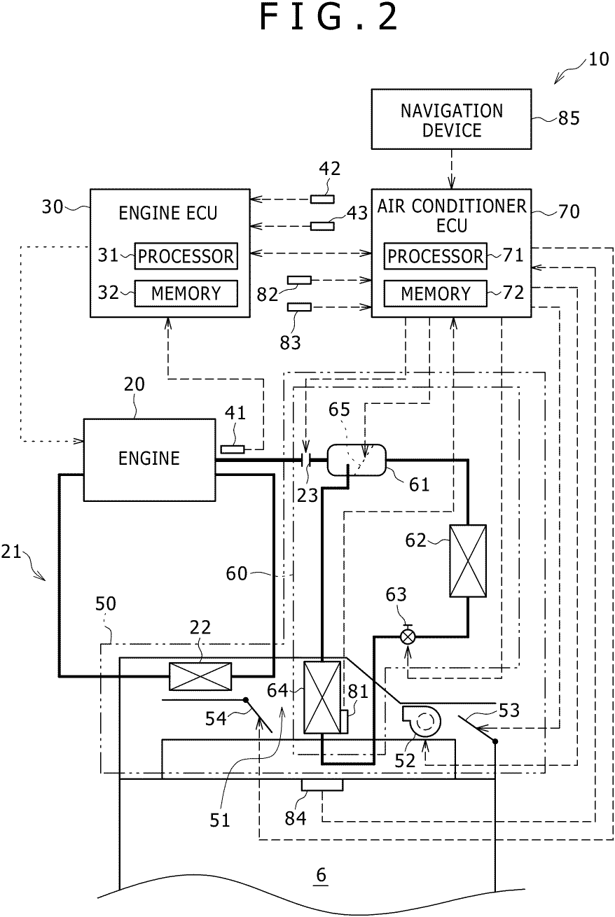

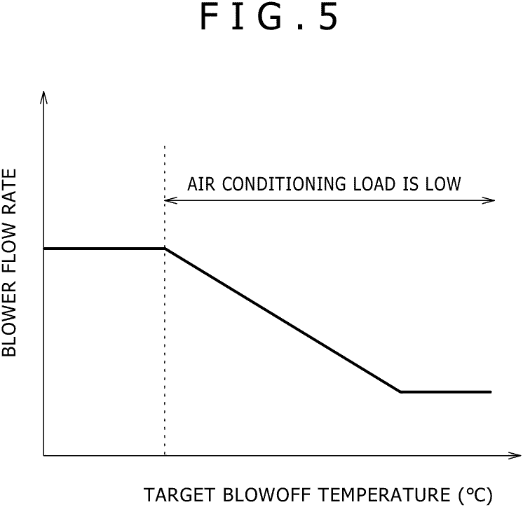

Referring to FIGS. 2 to 5, the vehicle control system 10 in the example according to the embodiment will be explained.

The vehicle control system 10 includes an engine ECU 30 which performs fuel cut control (hereinafter, abbreviated as “F/C control”) to stop fuel supply to the engine 20, and an air conditioner ECU 70 which controls an air conditioner 50 configured to condition air within a vehicle interior 6, the air conditioner 50 including a compressor 61 which is actuated by rotational driving force of the engine 20.

In the vehicle control system 10, the fuel efficiency of the vehicle 5 can be improved by allowing more situations where the F/C control is extended, which will be explained in detail below.

### Engine

As shown in FIG. 2, the engine 20 is cooled by an engine cooling circuit 21 and is controlled by the engine ECU 30. Further, the engine 20 is configured to drive the compressor 61 that is inserted in a refrigeration cycle circuit 60 of the air conditioner 50, which will be explained below, by means of a clutch 23. The engine cooling circuit 21 includes a heater core 22 installed in an air passage 51 of the air conditioner 50. The heater core 22 uses exhaust heat from the engine 20 to heat air flowing through the air passage 51.

### Engine ECU

As shown in FIG. 2, the engine ECU 30 includes a processor 31 which incorporates a CPU, and a memory 32 which stores a control program and control data, for example. The memory 32 may be implemented, for example, by a RAM, a ROM, a flash memory, or the like. The processor 31 is operated in accordance with the control program stored in the memory 32 to control the engine 20.

In addition, the engine ECU 30 is connected to an engine rpm sensor 41 which detects the rotational speed (rpm) of an engine 20, a vehicle speed sensor 42 which detects a speed of the vehicle 5, and an accelerator opening sensor 43 which detects an accelerator opening. The engine ECU 30 is also connected to the air conditioner ECU 70 which will be described further below.

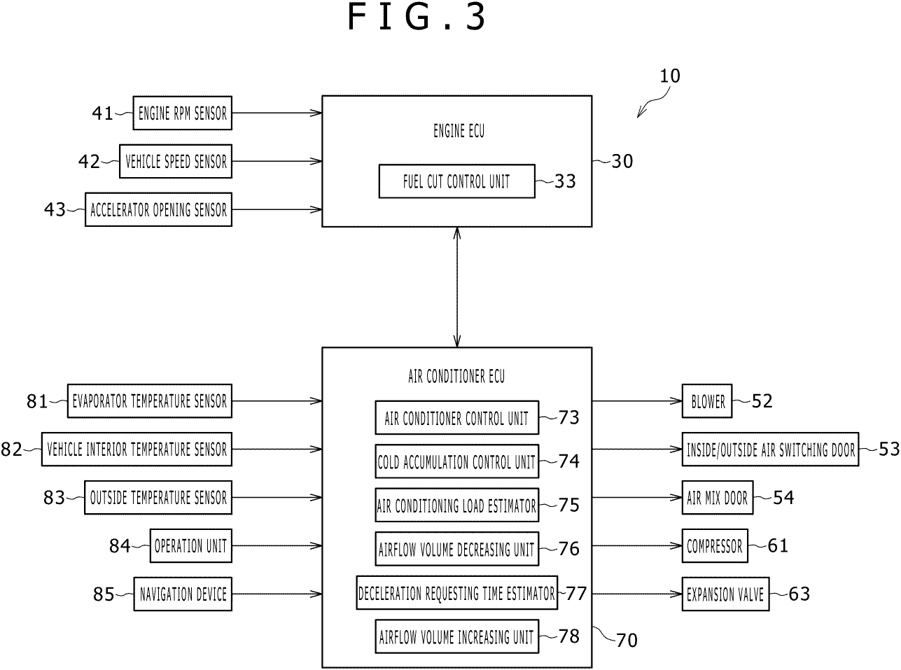

As shown in FIG. 3, the engine ECU 30 includes a fuel cut control unit 33 which performs the F/C control to stop fuel supply to the engine 20. The fuel cut control unit 33 is implemented by the processor 31 when the processor 31 executes the program stored in the memory 32.

The fuel cut control unit 33 starts the fuel cut control in response to a request for deceleration. Specifically, the fuel cut control unit 33 starts the fuel cut control when an accelerator opening is zero (i.e., the accelerator is released) and the vehicle speed matches or exceeds a third speed (of 40 km/h, for example). The fuel cut control unit 33 may start the fuel cut control when the accelerator opening is zero and an engine rpm matches or exceeds a third rpm (of 2000 rpm, for example).

A condition for the fuel cut control unit 33 to terminate the fuel cut control is that the vehicle speed matches or falls below a second speed (of 30 km/h, for example), or that the engine rpm matches or falls below a second rpm (of 1500 rpm, for example).

When the condition of terminating the F/C control is satisfied, however, in a case where the compressor 61 in the air conditioner 50 is deactivated, the fuel cut control unit 33 extends the fuel cut control until the vehicle speed matches or falls below a first speed (of 20 km/h, for example) which is lower than the second speed, or until the engine rpm matches or falls below a first rpm (of 1000 rpm, for example) lower than the second rpm. The reason for extending the fuel cut control will be explained below. During operation of the F/C control, an evaporator 64 is sufficiently cooled to accumulate the cold due to cold accumulation control performed by the air conditioner ECU 70, which will be described further below, and the compressor 61 is deactivated in a case where the temperature of the evaporator 64 matches or falls below a compressor deactivatable temperature when the condition of terminating the F/C control is satisfied. Because of this, there is no necessity for fuel to be supplied to the engine 20 in order to actuate the compressor 61, which can allow the F/C control to be extended, even though the engine rpm becomes lower than the second rpm, until the engine rpm is further decreased to the first rpm or lower.

It should be noted that values of the above-described engine rpm decrease in order from the third rpm, the second rpm, and the first rpm, while values of the vehicle speed decrease in order from the third speed, the second speed, and the first speed.

### Air Conditioner

As shown in FIG. 2, the air conditioner 50 includes the air passage 51 through which air is supplied into the vehicle interior 6, a blower 52 which generates an air flow directed into the vehicle interior 6, an inside/outside air switching door 53 which switches between feeding of air into the vehicle interior 6 (inside air) and feeding of air from outside the vehicle 5 (outside air), an air mix door 54 which switches between blowing of air into the heater core 22 and not blowing air into the heater core 22, and the refrigeration cycle circuit 60 which cools air flowing through the air passage 51.

The refrigeration cycle circuit 60 includes the compressor 61 which compresses a refrigerant, an outdoor heat exchanger 62 which condenses the refrigerant, an expansion valve 63 which expands the refrigerant, and the evaporator 64 disposed within the air passage 51. The compressor 61 is actuated by the engine 20. Further, the compressor 61 is of a variable capacity type, and has a capacity which can be increased or decreased by changing an angle of a swash plate 65. The evaporator 64 is equipped with an evaporator temperature sensor 81 which detects the temperature of the evaporator 64.

### Air Conditioner ECU

As shown in FIG. 2, the air conditioner ECU 70 includes the processor 71 incorporating a CPU, and a memory 72 for storing a control program and control data, for example. The memory 72 may be implemented by, for example, a RAM, a ROM, a flash memory, or the like. The processor 71 controls components installed in the air conditioner 50 when the processor 71 is operated in accordance with the control program stored in the memory 72.

The air conditioner ECU 70 is connected to the above-described evaporator temperature sensor 81, an inside air temperature sensor 82 which detects a temperature of air within the vehicle interior 6, an outside air temperature sensor 83 which detects a temperature of air in a region located outside the vehicle 5, an operation unit 84 which is used for operation to set the present temperature of the air conditioner 50, and a navigation device 85 which performs route guidance to a destination based on a present location of the vehicle 5, and is configured to receive sensor signals from the evaporator temperature sensor 81, the inside air temperature sensor 82, and the outside air temperature sensor 83, receive an operation signal from the operation unit 84, and acquire information of an estimated travel route from the navigation device 85. The information of the travel route includes road inclination information, stop signs on roads, and information regarding traffic congestion.

Further, the air conditioner ECU 70 is connected to the clutch 23, the blower 52, the inside/outside air switching door 53, the air mix door 54, the compressor 61, and the expansion valve 63, and is configured to send thereto control signals for connecting or disconnecting between the engine 20 and the compressor 61, regulating an airflow volume supplied by the blower 52, adjusting an opening of the inside/outside air switching door 53, adjusting an opening of the air mix door 54, changing the capacity of the compressor 61, and adjusting an opening of the expansion valve 63. In addition, the air conditioner ECU 70 is also connected to the above-described engine ECU 30.

As shown in FIG. 3, the air conditioner ECU 70 includes control blocks of an air conditioner control unit 73, a cold accumulation control unit 74, an air conditioner load estimator 75, an airflow volume decreasing unit 76, a deceleration requesting time estimator 77, and an airflow volume increasing unit 78, which will be respectively explained in detail below. The air conditioner control unit 73, the cold accumulation control unit 74, the air conditioner load estimator 75, the airflow volume decreasing unit 76, the deceleration requesting time estimator 77, and the airflow volume increasing unit 78 are implemented by the processor 71 when the processor 71 executes the program stored in the memory 72.

The air conditioner control unit 73 controls components of the air conditioner 50 to establish a preset temperature of the vehicle compartment 6. More specifically, the air conditioner control unit 73 calculates a target blowoff temperature, a target airflow volume, a target inside/outside air switching door opening, and a target air mix door opening, based on an outside air temperature, an inside air temperature, and the present temperature. Further, the air conditioner control unit 73 regulates the airflow volume supplied by the blower 52, the opening of the inside/outside air switching door 53, and the opening of the air mix door 54, activates or deactivates the compressor 61, adjusts the capacity of the compressor 61, and regulates the opening of the expansion valve 63, so as to attain the calculated target blowoff temperature, the target airflow volume, and the target inside/outside air switching door opening and the target air mix door opening.

The cold accumulation control unit 74 operates the compressor 61 to cool the evaporator for accumulating the cold during operation under the F/C control performed by the engine ECU 30. In this way, rotational driving energy from the engine 20 during operation under the F/C control can be utilized for cooling the evaporator 64 to accumulate the cold therein.

Further, the cold accumulation control unit 74 sets the capacity of the compressor 61 to the maximum capacity for allowing the compressor 61 to operate at its maximum output during operation with the cold accumulation control. This can allow the air conditioner 50 to utilize most of the rotational driving energy from the engine 20 during operation of the F/C control.

Still further, the cold accumulation control unit 74 deactivates the compressor 61 in a case where the temperature of the evaporator 64 matches or falls below the compressor deactivatable temperature when the condition of terminating the F/C control is satisfied. On the other hand, when the temperature of the evaporator 64 is higher than the compressor deactivatable temperature, the cold accumulation control unit 74 maintains operation of the compressor 61, while the air conditioner controller 73 controls the components of the air conditioner 50 to maintain the vehicle interior 6 at the preset temperature.

The air conditioning load estimator 75 estimates an air conditioning load based on at least one of the outside air temperature, the target blowoff temperature, and the vehicle interior temperature.

The airflow volume decreasing unit 76 decreases the airflow volume supplied by the blower 52 when an estimated air conditioning load is low. In the refrigeration cycle circuit 60, when the airflow volume supplied by the blower 52 is decreased, heat exchange efficiency of the evaporator 64 is decreased and the evaporator temperature is accordingly lowered. That is, the decrease in the airflow volume from the blower 52 during operation to accumulate the cold causes the temperature of the evaporator 64 to be rapidly lowered to the compressor deactivatable temperature, which can increase the occurrence of a situation in which the temperature of the evaporator 64 matches or falls below the compressor deactivatable temperature when the condition of terminating the F/C control is satisfied. In other words, the occurrence of situations where the compressor 61 is deactivated when the condition for terminating the F/C control is satisfied can be increased, leading to an increased occurrence of situations where the F/C control is extended. In this way, the fuel economy of the vehicle 5 can be improved.

It should be noted that when the air conditioning load is low, comfort within the vehicle interior 6 is maintained even though the airflow volume supplied by the blower 52 is decreased.

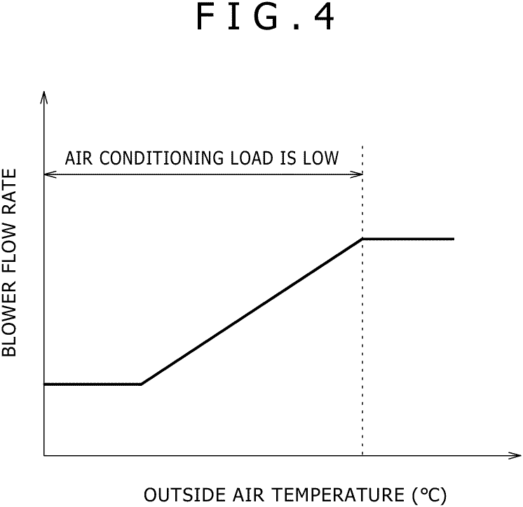

When the air conditioning load estimator 75 estimates the air conditioning load based on the outside air temperature, because the air conditioning load is low at an outside air temperature that matches or falls below a predetermined outside air temperature as shown in FIG. 4, the airflow volume decreasing unit 76 decreases the airflow volume supplied by the blower 52 as the outside air temperature decreases from the predetermined outside air temperature, to thereby rapidly decrease the temperature of the evaporator 64 for the purpose of increasing frequency of occurrence of situations where the compressor 61 is deactivated. It should be noted that also in a case where the air conditioning load estimator 75 estimates the air conditioning load based on the vehicle interior temperature, the airflow volume decreasing unit 76 decreases the airflow volume supplied by the blower 52 as the vehicle interior temperature decreases, as in the case of the example shown in FIG. 4.

When the air conditioning load estimator 75 estimates the air conditioning load based on the target blowoff temperature, the airflow volume decreasing unit 76 decreases the airflow volume supplied by the blower 52 as the target blowoff temperature is increased from a predetermined target blowoff temperature, to thereby rapidly decrease the temperature of the evaporator 64 for the purpose of increasing frequency of occurrence of situations whjere the compressor 61 is deactivated.

The deceleration requesting time estimator 77 estimates, based on information of the estimated travel route acquired from the navigation device 85, the length of deceleration requesting time. When there is a long downhill stretch in the estimated travel route, for example, the deceleration requesting time estimator 77 estimates that the deceleration requesting time is longer. On the other hand, when there are a great number of stop signs or there is traffic congestion on the estimated travel route, the deceleration request continuation estimator 77 estimates that the deceleration requesting time is short.

The airflow volume increasing unit 78 increases the airflow volume supplied by the blower 52 when the estimated air conditioning load is high and the estimated deceleration requesting time is long. In the refrigeration cycle circuit 60, the heat exchange efficiency of the evaporator 64 is increased due to the increased airflow volume from the blower 52, which causes the evaporator temperature to be gradually decreased. That is, when the airflow volume supplied by the blower 52 is increased during the operation to accumulate the cold, the temperature of the evaporator 64 is gradually decreased and accordingly hindered from reaching a preset temperature of freeze prevention control. As a result, the occurrence of situations where the compressor 61 is deactivated due to the freeze prevention control is less likely. Here, the freeze prevention control denotes a control operation which is performed to deactivate the compressor 61 when the temperature of the evaporator 64 reaches the preset temperature, in order to prevent the evaporator 64 from freezing up. In this example, because the frequency of occurrence of situations where the compressor 61 is deactivated due to the freeze prevention control during operation under the cold accumulation control is decreased, the rotational driving energy obtained when the F/C control is performed can be effectively utilized in the air conditioner 50 for accumulating the cold without wasting energy.

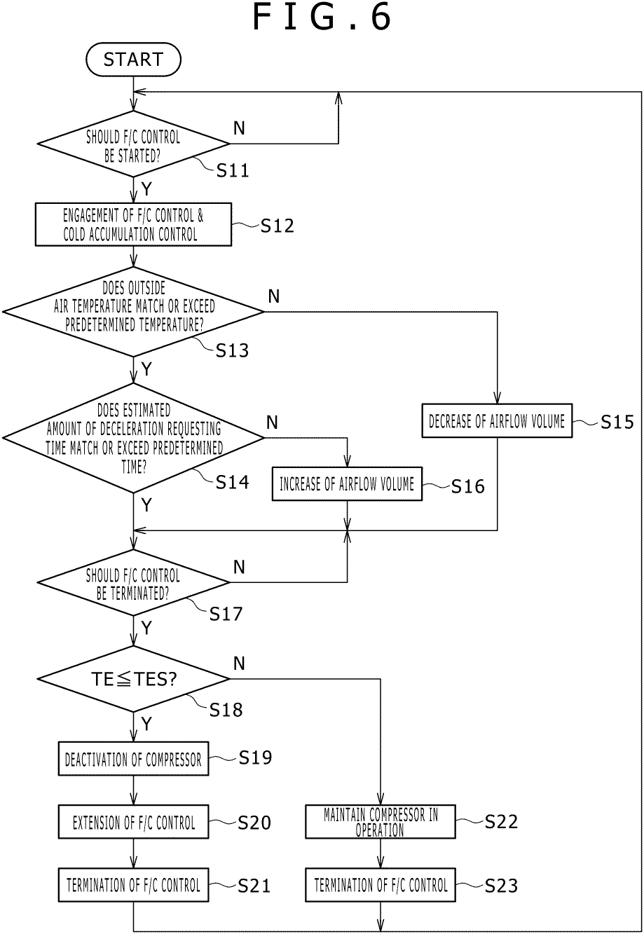

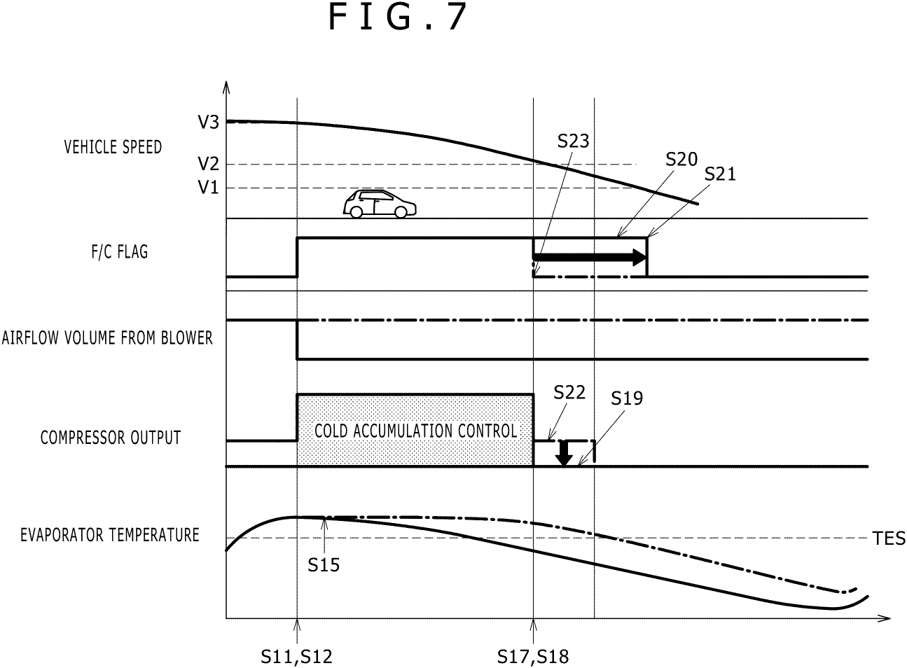

A flow of process steps performed by the Engine ECU 30 and the air conditioner ECU 70 will be explained with reference to FIGS. 6 and 7.

As shown in FIG. 6, when the vehicle speed is decreased to a third speed V3 or lower in response to release of the accelerator, for example, the fuel cut control unit 33 in the engine ECU 30 determines, in step S11, that the F/C control should be started, and operation moves to step S12.

In step S12, the fuel cut control unit 33 performs the F/C control. Simultaneously with this, the cold accumulation control unit 74 in the air conditioner ECU 70 changes the angle of the swash plate 65 in the compressor 61 so as to maximize the capacity of the compressor 61 and operates the compressor 61 at its maximum output to cool the evaporator 64 for accumulating the cold therein.

In step S13, the air conditioning load estimator 75 in the air conditioner ECU 70 determines whether or not the outside air temperature is lower than the predetermined temperature, in order to estimate the air conditioning load based on the outside air temperature, for example. When the outside air temperature is determined to match or exceed the predetermined temperature (i.e., the air conditioning load is high), operation moves to step S14. When the outside air temperature is determined to be lower than the predetermined temperature (i.e., the air conditioning load is low), operation moves to step S15.

In step S14, it is determined whether or not the deceleration requesting time estimated by the deceleration requesting time estimator 77 matches or falls below a predetermined time. When the estimated deceleration requesting time is determined to match or fall below the predetermined time, operation moves to step S17. On the other hand, when the estimated deceleration requesting time is determined to be greater than the predetermined time, operation moves to step S16.

In step S15, the airflow volume decreasing unit 76 decreases the airflow volume supplied by the blower 52 to thereby rapidly lower the evaporator temperature. In this way, the occurrence of situations in which an evaporator temperature TE reaches or falls below a compressor deactivatable temperature TES in step S18, which will be described below, is increased, to thereby increase the frequency of occurrence of situations in which the compressor 61 is deactivated (step S19), and accordingly increase the occurrence of situations in which the F/C control is extended (step S20).

In step S16, the airflow volume increasing unit 78 increases the airflow volume supplied by the blower 52, to thereby gradually lower the evaporator temperature. This decreases the occurrence of situations in which the compressor 61 is deactivated due to the freeze prevention control during operation under the cold accumulation control. In this way, the rotational driving energy obtained when the F/C control is performed can be effectively utilized by the air conditioner 50 to accumulate the cold, without wasting the energy.

In step S17, the fuel cut control unit 33 determines, when the vehicle speed matches or falls below the second speed V2, that the condition for terminating the F/C control is satisfied, and operation moves to step S18.

In step S18, the cold accumulation control unit 74 determines whether or not the evaporator temperature TE matches or falls below the compressor deactivatable temperature TES. When the evaporator temperature TE is determined to match or fall below the compressor deactivatable temperature TES, operation moves to step S19. When the evaporator temperature TE is determined to be greater than the compressor deactivatable temperature TES, operation moves to step S22.

In step 19, the cold accumulation control unit 74 deactivates the compressor 61. In step S20, the fuel cut control unit 33 in the engine ECU 30 extends the F/C control. In step S21, the fuel cut control unit 33 terminates the F/C control when the vehicle speed matches or falls below the first speed V1.

In step S22, the cold accumulation control unit 74 maintains operation of the compressor 61. In step S23, the fuel cut control unit 33 in the engine ECU terminates the F/C control. Then, the air conditioner control unit 73 controls the components of the air conditioner 50 to establish the preset temperature of the vehicle interior 6.

As shown in FIG. 7, when the outside air temperature, for example, used as a basis for estimating the air conditioning load is low, the evaporator temperature has conventionally been decreased gradually to the compressor deactivatable temperature without decreasing the airflow volume during the cold accumulating control operation, which causes the compressor 61 to be in operation at the time of terminating the F/C control (indicated by alternate long and short dashed lines in FIG. 7). As opposed to such a conventional case, in the vehicle control system 10 according to this embodiment, even though the outside air temperature is low, the evaporator temperature is rapidly lowered to the compressor deactivatable temperature by decreasing the airflow volume during operation under the cold accumulation control, which allows the compressor 61 to be deactivated (indicated by solid lines in FIG. 7). As a result, the frequency of occurrence of situations where the F/C control is extended can be increased, and the fuel efficiency of the vehicle 5 can be accordingly improved.

The present disclosure is not limited to the above-described embodiment or modification examples thereof, and the components and features described herein may be changed or improved in various ways without departing from the scope of the accompanying claims.

1. A vehicle control system, comprising:
an engine controller configured to perform fuel cut control for stopping fuel supply to an engine; and
an air conditioner controller configured to control an air conditioner comprising a compressor which is driven by a rotational driving force of the engine, wherein
the engine controller is further configured to start the fuel cut control in response to a request for deceleration;
the air conditioner controller is further configured to operate the compressor for accumulating coldness while the fuel cut control operation is being performed by the engine controller, and deactivate the compressor in a case where a temperature of an evaporator matches or falls below a compressor deactivatable temperature when a condition for terminating the fuel cut control is satisfied;
the engine controller is further configured to extend the fuel cut control in a case where the compressor is deactivated when the condition for terminating the fuel cut control is satisfied; and
the air conditioner controller further comprises an airflow volume decreasing unit configured to decrease an airflow volume supplied by a blower when an estimated air conditioning load is low during operation to accumulate coldness, for causing the temperature of the evaporator to be rapidly decreased, the blower being configured to blow air into a vehicle interior.

2. The vehicle control system according to claim 1, wherein the air conditioner controller further comprises an air conditioning load estimator configured to estimate the air conditioning load based on at least one of an outside air temperature, a target blowoff temperature, and a vehicle interior temperature.

3. The vehicle control system according to claim 1, wherein:
the air conditioner controller comprises an airflow volume increasing unit configured to increase the airflow volume supplied by the blower when it is estimated that a deceleration requesting time is great, for causing the temperature of the evaporator to be gradually decreased during the operation to accumulate coldness.

4. The vehicle control system according to claim 2, wherein:
the air conditioner controller comprises an airflow volume increasing unit configured to increase the airflow volume supplied by the blower when it is estimated that a deceleration requesting time is great, for causing the temperature of the evaporator to be gradually decreased during the operation to accumulate coldness.
